(19) United States
(12) Patent Application Publication
(10) Pub. No.: US 2023/0281277 A1
(43) Pub. Date: Sep. 7, 2023

(54) REMOTE AGENT IMPLEMENTATION OF REINFORCEMENT LEARNING POLICIES

(71) Applicant: Microsoft Technology Licensing, LLC, Redmond, WA (US)

(72) Inventor: Johannes Hendrik VERWEY, Vancouver (CA)

(73) Assignee: Microsoft Technology Licensing, LLC, Redmond, WA (US)

(21) Appl. No.: 17/688,538

(22) Filed: Mar. 7, 2022

(51) Int. Cl. G06K 9/62; G06N 5/04; G06N 5/02

(52) U.S. Cl. CPC G06K 9/6262; G06N 5/025; G06N 5/043

(57) ABSTRACT

This document relates to reinforcement learning. One example includes performing two or more training iterations to update a policy. Individual training iterations can be performed by a training process executing on a training computing device. The training iterations can include obtaining experiences representing reactions of an environment to actions taken by a plurality of remote agent processes according to the policy. The remote agent processes can execute the policy on remote agent computing devices and the experiences can be obtained from the remote agent computing devices over a network. The training iterations can also include updating the policy based on the reactions of the environment to obtain an updated policy and distributing the updated policy over the network to the plurality of remote agent processes.

### BACKGROUND

Reinforcement learning enables machines to learn policies according to a defined reward function. In some cases, reinforcement learning algorithms can train a model using agents that communicate synchronously with a centralized trainer. This approach can have numerous drawbacks, however.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for configuring an agent to perform reinforcement learning. One example includes a method or technique that can include performing two or more training iterations to update a policy. Individual training iterations can include, by a training process executing on a training computing device, obtaining experiences representing reactions of an environment to actions taken by a plurality of remote agent processes according to the policy. The remote agent processes execute the policy on remote agent computing devices and the experiences are obtained from the remote agent computing devices over a network. The method or technique can also include, by the training process, updating the policy based on the reactions of the environment to obtain an updated policy. The method or technique can also include, by the training process, distributing the updated policy over the network to the plurality of remote agent processes.

Another example includes a method or technique that can include performing two or more experience-gathering iterations. Individual experience-gathering iterations can include, by an agent process executing on an agent computing device, obtaining an updated policy provided by a training process on a training computing device. The training computing device can be remote from the agent computing device and the updated policy can be obtained over a network. The method or technique can also include, by the agent process, taking actions in an environment by executing the updated policy locally on the agent computing device. The method or technique can also include, by the agent process, publishing experiences representing reactions of the environment to the actions taken according to the updated policy. The experiences can be published to the training process to further update the policy for use in a subsequent experience-gathering iteration by the agent process.

Another example includes a system having a training computing device that includes a hardware processing unit and a storage resource storing computer-readable instructions. When executed by the hardware processing unit, the computer-readable instructions can cause the hardware processing unit to execute a training process. The training process can be configured to perform two or more training iterations to update a policy. Individual training iterations can include obtaining experiences representing reactions of an environment to actions taken by a plurality of remote agent processes according to the policy. The remote agent processes can execute the policy on remote agent computing devices and the experiences can be obtained from the remote agent computing devices over a network. Individual training iterations can also include using reinforcement learning to update the policy based on the reactions of the environment to obtain an updated policy. Individual training iterations can also include distributing the updated policy over the network to the plurality of remote agent processes.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example of an agent interacting with an environment, consistent with some implementations of the present concepts.

FIG. 2 illustrates an example agent that can be configured using reinforcement learning, consistent with some implementations of the present concepts.

FIG. 3 illustrates an example of communications between a trainer and a single instance of a remote agent, consistent with some implementations of the present concepts.

FIG. 4 illustrates an example of communications between a trainer and multiple instances of remote agents, consistent with some implementations of the present concepts.

FIG. 5 illustrates example workflows for training of a policy using reinforcement learning, consistent with some implementations of the disclosed techniques.

FIG. 6 illustrates an example system, consistent with some implementations of the disclosed techniques.

FIG. 7 is a flowchart of an example method for a training process to perform reinforcement learning of a policy, consistent with some implementations of the present concepts.

FIG. 8 is a flowchart of an example method for a remote agent process to gather experiences for reinforcement learning, consistent with some implementations of the present concepts.

FIGS. 9, 10A, and 10B illustrate example application scenarios where reinforcement learning can be employed, consistent with some implementations of the present concepts.

FIG. 11 illustrates an example graphical user interface for configuring reinforcement learning, consistent with some implementations of the present concepts.

### DETAILED DESCRIPTION

### Overview

Reinforcement learning generally aims to learn a policy that maximizes or increases the sum of rewards of a specified reward function. For instance, reinforcement learning can balance exploring new actions and exploiting knowledge gained by rewards received for previous actions. One way to learn a policy using reinforcement learning in distributed scenarios involves the use of a centralized trainer that directly coordinates the actions of one or more remote agents. For instance, the centralized trainer can instruct the remote agents to perform actions according to a policy, collect environmental reactions to the actions, and update the policy according to the reactions received from the remote agents. Once the policy is fully trained, the final policy can be distributed to the remote agents, but during training the trainer decides the actions that are taken by the remote agents.

Because the trainer decides the actions taken by the remote agents during training, this centralized approach can involve synchronous communication with the remote agents. Each time the trainer instructs the remote agents to take an action, a network communication occurs from the trainer to a remote agent. Each time the agent collects an environmental reaction, the agent communicates the reaction to the trainer using another network communication. Thus, this centralized approach can involve the use of a persistent network connection between the trainer and each remote agent, and also can involve the agent waiting for instructions from the centralized trainer before taking any actions during training.

A refinement on the above centralized approach can parallelize the gathering of experiences and allow for training to occur asynchronously from gathering experiences. This refinement involves the use of parallel worker processes that determine the actions and collect the experiences via synchronous communication with various remote agents. The worker processes can asynchronously populate a buffer that is used by a trainer to update the policy. The worker processes can then receive the updated policy and use the updated policy to control the actions taken by the remote agents. However, while this refinement allows for asynchronous communication between the worker processes and the trainer, it still involves synchronous communication between the remote agents and the worker processes. As discussed more below, this can cause performance issues when scaled to many remote agents as well as other technical difficulties.

The disclosed implementations can mitigate these deficiencies of the above-described approaches by asynchronously publishing iterations of policies to remote agents during training. The remote agents can then implement the policy locally and asynchronously communicate experiences to the trainer. By implementing the policy locally on the remote agents during training, the remote agents do not necessarily need to communicate synchronously with the trainer or a worker process. Instead, each remote agent can publish gathered experiences to an experience data store that is accessible to the trainer. The trainer can pull experiences from the experience data store, update the policy, and communicate the updated policy to the remote agents for further training. This can continue until a final policy is obtained, at which point the trainer can distribute the final policy to the remote agents, which can then switch from training mode to inference mode.

### Reinforcement Learning Overview

Reinforcement learning generally involves an agent taking various actions in an environment according to a policy, and adapting the policy based on the reaction of the environment to those actions. Reinforcement learning does not necessarily rely on labeled training data as with supervised learning. Rather, in reinforcement learning, the agent evaluates reactions of the environment using a reward function and aims to determine a policy that tends to maximize or increase the cumulative reward for the agent over time.

In some cases, a reward function can be defined by a user according to the reactions of an environment, e.g., 1 point for a desired outcome, 0 points for a neutral outcome, and -1 point for a negative outcome. The agent proceeds in a series of steps, and in each step, the agent has one or more possible actions that the agent can take. For each action taken by the agent, the agent observes the reaction of the environment. The agent or a trainer can calculate a corresponding reward according to the reward function, and the trainer can update the policy based on the calculated reward.

Reinforcement learning can strike a balance between “exploration” and “exploitation.” Generally, exploitation prioritizes taking actions that are expected to maximize the immediate reward given the current policy, and exploration prioritizes taking actions that do not necessarily maximize the expected immediate reward but that search unexplored or under-explored actions. In some cases, the agent may select an exploratory action in that ultimately results in a greater cumulative reward than the best action according to its current policy, and the agent can update its policy to reflect the new information.

In some reinforcement learning scenarios, an agent can utilize context describing the environment that the agent is interacting with in order to choose which action to take. For instance, the policy can be implemented as a neural network that receives context features describing the current state of the environment and uses these features to determine an output. At each step, the model may output a probability density function over the available actions (e.g., using Softmax), where the probabilities are proportional to the expected reward for each action.

The agent can select an action randomly from the probability density function, with the likelihood of selecting each action corresponding to the probability output by the neural network. The model may learn weights that are applied to one or more input features (e.g., describing context) to determine the probability density function. Based on the reward obtained in each step, the trainer can update the weights used by the neural network to determine the probability density function.

In some instances, the neural network (e.g., with one or more recurrent layers) can keep a history of rewards earned for different actions taken in different contexts and continue to update the policy as new information is discovered. Other types of models can also be employed, e.g., a linear contextual bandit model such as Vowpal Wabbit. The disclosed implementations can be employed with various types of reinforcement learning algorithms and model structures.

Some machine learning models suitable for reinforcement learning, such as neural networks, use layers of nodes that perform specific operations. In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned. Note that two trained models can share the same model structure and yet have different values for the internal parameters, e.g., if the two models are trained on different training data or if there are underlying stochastic processes in the training process.

### Definitions

For the purposes of this document, an agent is an automated entity that can take actions within an environment. For instance, an agent can determine a probability distribution over one or more actions that can be taken within the environment, and/or select a specific action to take. An agent can determine the probability distribution and/or select the actions according to a policy. For instance, the policy can map environmental context to probabilities for actions that can be taken by the agent. The policy can be refined by a trainer using a reinforcement learning algorithm that updates the policy based on reactions of the environment to actions selected by the agent.

A reinforcement learning model can be trained to learn a policy using a reward function. The trainer can update the internal parameters of the policy by observing reactions of the environment and evaluating the reactions using the reward function. As noted previously, the term “internal parameters” is used herein to refer to learnable values such as weights that can be learned by training a machine learning model, such as a linear model or neural network.

A reinforcement learning model can also have hyperparameters that control how the agent acts and/or learn. For instance, a reinforcement learning model can have a learning rate, a loss function, an exploration strategy, etc. A reinforcement learning model can also have a feature definition, e.g., a mapping of information about the environment to specific features used by the model to represent that information. A feature definition can include what types of information the model receives, as well as how that information is represented. For instance, two different feature definitions might both indicate that a model receives a context feature describing an age of a user, but one feature definition might identify a specific age in years (e.g., 24, 36, 68, etc.) and another feature definition might only identify respective age ranges (e.g., 21-30, 31-40, and 61-70).

Reinforcement learning can be implemented in one or more processes on one or more computing devices. A process on a computing device can include executable code, memory, and state. In some implementations, a centralized trainer can run in a trainer process on one computing device and asynchronously distribute policies over a network to multiple remote agents running in separate remote agent processes on other computing devices. The remote agent processes can collect events as they implement the policy and asynchronously communicate batches of events to the trainer process for further training.

### Example Learning Framework

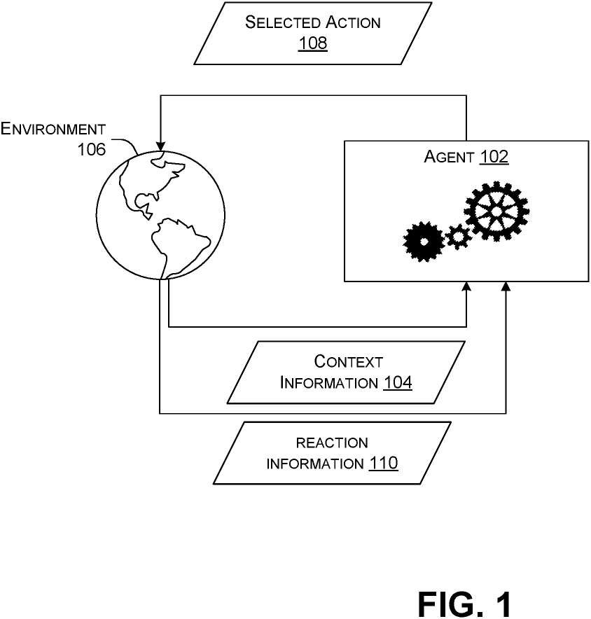

FIG. 1 shows an example where an agent 102 receives context information 104 representing a state of an environment 106. The agent can determine a selected action 108 to take based on the context information, e.g., based on a current policy. The agent can receive reaction information 110 which represents how the state of the environment changes in response to the action selected by the agent. The reaction information 110 can be used in a reward function to determine a reward for the selected action based on how the environment has changed in response to the selected action.

In some cases, the actions available to an agent can be independent of the context - e.g., all actions can be available to the agent in all contexts. In other cases, the actions available to an agent can be constrained by context, so that actions available to the agent in one context are not available in another context. Thus, in some implementations, context information 104 can specify what the available actions are for an agent given the current context in which the agent is operating.

### Example Agent Components

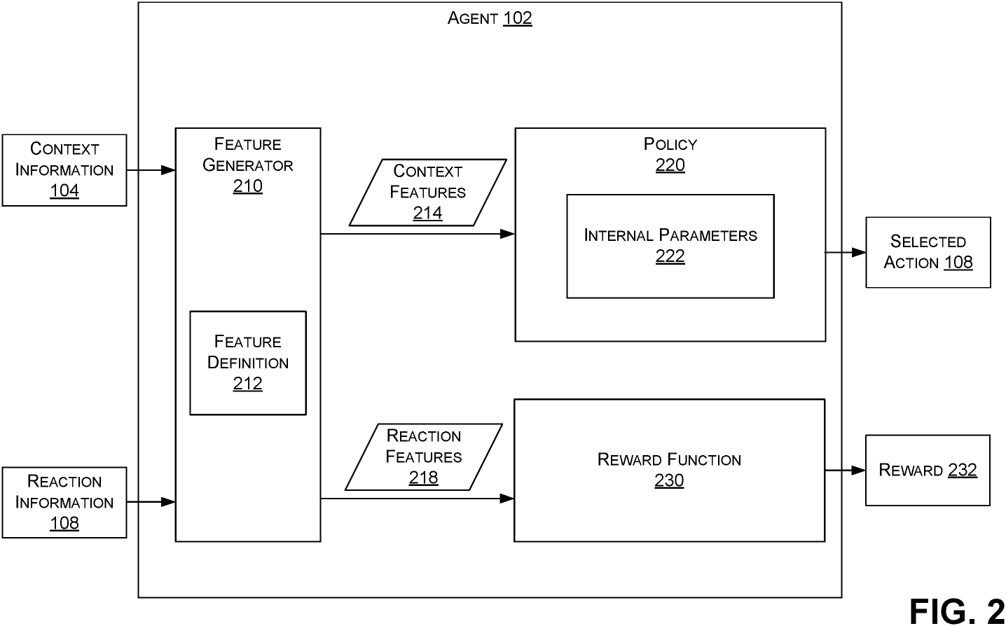

FIG. 2 illustrates components of agent 102, such a feature generator 210, a policy 220, and a reward function 230. The feature generator 210 uses feature definition 212 to generate context features 214 from context information 104 and to generate reaction features 218 from reaction information 110. The context features represent a context of the environment in which the agent is operating, and the reaction features represent how the environment reacts to an action selected by the agent. Thus, the reaction information may be obtained later in time than the context information.

The agent 102 can execute the policy 220 by inputting the context features to the policy and then using the output of the policy to determine the selected action 108 to take. For instance, given a set of context features 214, the internal parameters 222 of the policy can be used to compute a probability distribution such as (Action A, probability 0.8, Action B, probability 0.2). The agent can take action A with a probability of 80% and action B with a probability of 20%, e.g., by generating a random number between 0 and 1 and taking Action A if the number is 0.80 or lower, and by taking Action B if the number is higher.

Using reward function 230, the agent can calculate a reward 232 based on the reaction features 218. In some cases, the reward may also be a function of the context features. For instance, the reward for a given environmental reaction may be greater in some contexts than in other contexts.

### Example Communications Scenarios

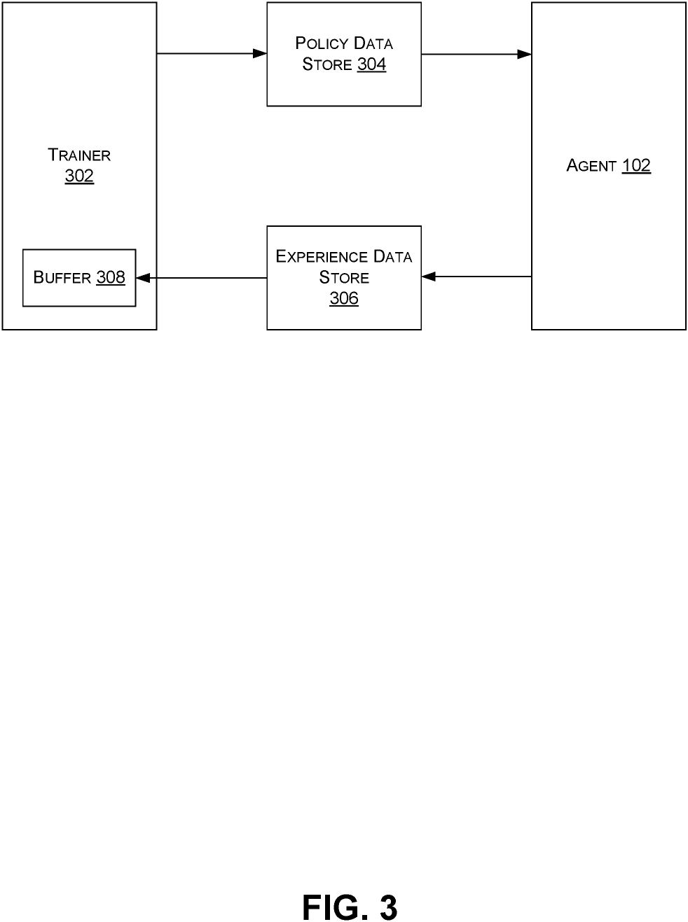

FIG. 3 illustrates an example communication scenario with a single agent 102 and a trainer 302. Trainer 302 can asynchronously publish policies to a policy data store 304. The agent can periodically retrieve the current policy from the policy data store, and act according to the policy for a period of time. The agent can publish experiences to an experience data store 306 that is accessible to the trainer. The trainer can maintain a buffer 308 of experiences that it uses to update the policy, e.g., by modifying internal parameters of the policy.

Note that the implementation shown in FIG. 3 does not necessarily require synchronous communication between the agent 102 and the trainer 302. Indeed, the agent and trainer do not even necessarily need to maintain a persistent network connection while the agent implements the policy. Rather, the agent can open a temporary network connection to retrieve the current policy from the policy queue, close the network connection, and implement the current policy for a period of time to collect a group of experiences (e.g., a training batch). Once the group of experiences has been collected, the agent can open another connection to the experience data store 306, publish the batch of experiences, and close the connection.

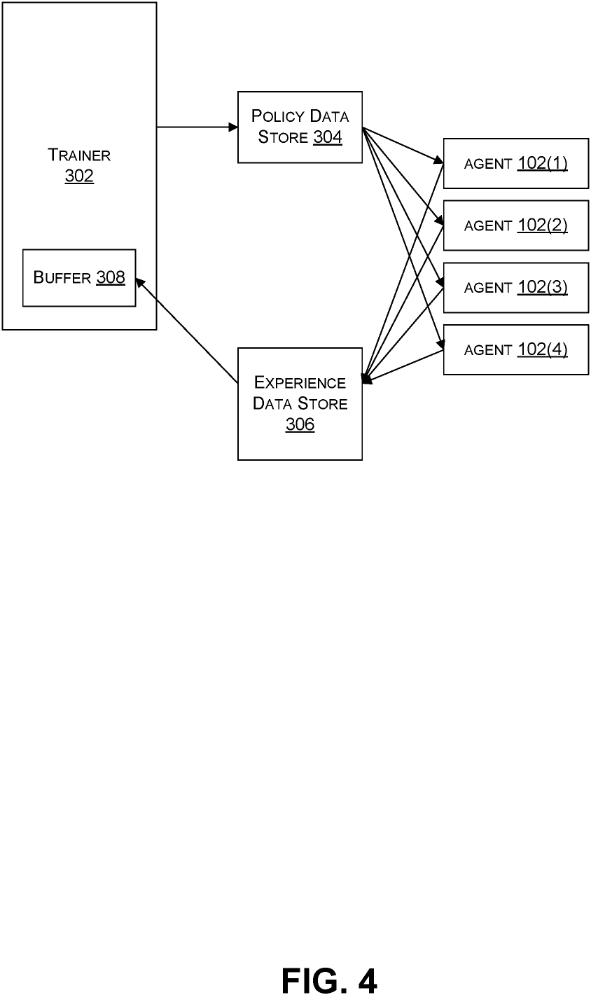

FIG. 4 illustrates another communication scenario similar to that described with respect to FIG. 3, with multiple agents 102(1), 102(2), 102(3), and 104(4). In this example, multiple agents retrieve the current policy from policy data store 304, which is shared by each of the multiple agents. The respective agents each publish gathered experiences to an experience data store 306. Because the policy and experience data store are implemented using shared resources such as shared network folders or persistent cloud queues, multiple agents can run in parallel while independently collecting experiences according to the latest policy. Each individual agent can communicate asynchronously with the trainer as described above with respect to FIG. 3.

### Example Workflows

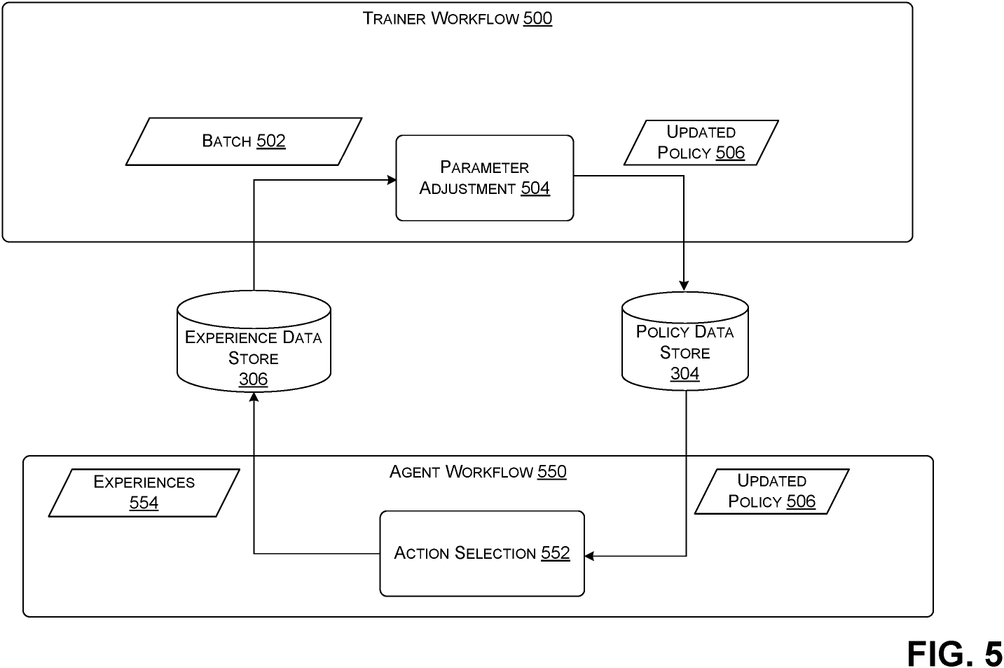

FIG. 5 illustrates example workflows for training of a reinforcement learning model, consistent with some implementations. Training workflow 500 can be performed by a trainer, and agent workflow 550 can be performed by one or more agents.

Training workflow 500 involves obtaining a batch 502 of experiences from experience data store 306 that is populated with the experiences. Then, parameter adjustment 504 can be employed to update internal parameters of a policy to obtain an updated policy 506, which can be published to policy data store 304. Training can proceed iteratively over multiple training iterations. Each experience in a given batch can have a corresponding reward value, either computed by the agent or the trainer from the reaction of the environment to a selected action. The parameter adjustment process can adjust parameters of the machine learning model based on the reward values, e.g., using Q learning, policy gradient, or another method of adjusting internal parameters of a model based on reward values. In each training iteration, parameter adjustment can be performed by starting with the parameters of the policy determined in the previous iteration. Once the parameters are updated, the updated model is published to policy data store 304, which is accessible to the agent(s) that implement the policy. After several iterations, the most recent updated model can be designated as a final model. For instance, training can end when one or more stopping conditions are reached, such as a fixed number of iterations have been performed or a convergence condition is reached, e.g., where the magnitude of changes to the internal parameters is below a specified threshold for a specified number of iterations.

Agent workflow 550 involves obtaining the updated policy 506 from policy data store 304. The agent can perform action selection 552 according to the updated policy based on environmental context, as described previously. Experiences 554 can be published to the experience data store 306. Each experience can identify the action that was taken, the context in which the action was taken, and/or the reward value calculated for the selected action.

### Example System

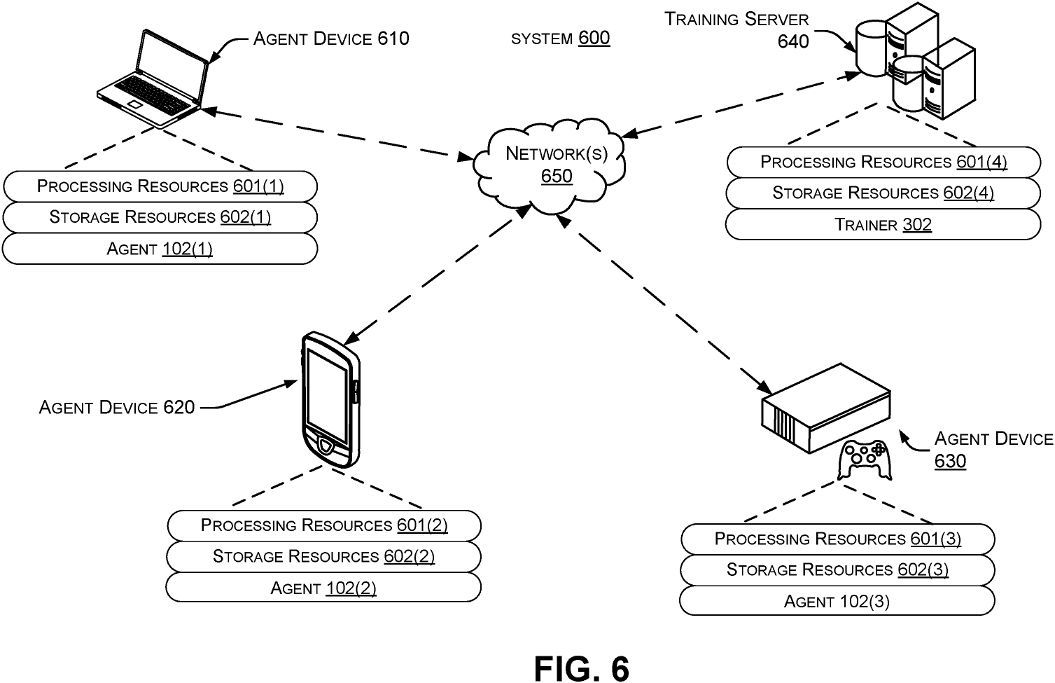

The present implementations can be performed in various scenarios on various devices. FIG. 6 shows an example system 600 in which the present implementations can be employed, as discussed more below.

As shown in FIG. 6, system 600 includes an agent device 610, an agent device 620, an agent device 630, and a training server 640, connected by one or more network(s) 650. Note that the agent devices can be embodied both as mobile devices such as smart phones and/or tablets, as well as stationary devices such as desktops, server devices, etc. Likewise, the servers can be implemented using various types of computing devices. In some cases, any of the devices shown in FIG. 6, but particularly the servers, can be implemented in data centers, server farms, etc.

Certain components of the devices shown in FIG. 6 may be referred to herein by parenthetical reference numbers. For the purposes of the following description, the parenthetical (1) indicates an occurrence of a given component on agent device 610, (2) indicates an occurrence of a given component on agent device 620, (3) indicates an occurrence of a given component on agent 630, and (4) indicates an occurrence of a given component on training server 640. Unless identifying a specific instance of a given component, this document will refer generally to the components without the parenthetical.

Generally, the devices 610, 620, 630, and/or 640 may have respective processing resources 601 and storage resources 602, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Training server 640 can include trainer 302, which can execute in a corresponding training process on the training server. As noted previously, the trainer can publish a policy to the agents, retrieve experiences from the agents, and update the policy in an iterative fashion. Once training is complete, the trainer can publish a final policy and instruct the respective agents 102 to enter inference mode. As noted previously, experience and/or policy data stores can be implemented using shared network resources, but in other implementations can be provided at specific memory locations on the training server.

Agent devices 610, 620, and 630 can each include respective instances of an agent executing in a corresponding remote agent process. As noted previously, the agents can retrieve a current policy, take actions according to the policy, and publish experiences to the trainer 302.

### Example Trainer Method

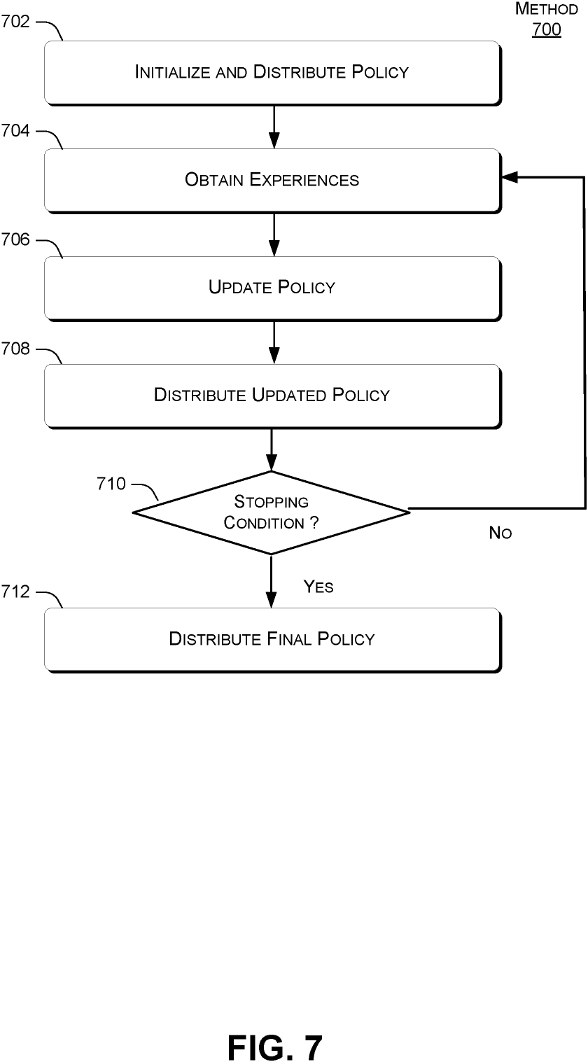

FIG. 7 illustrates an example method 700, consistent with some implementations of the present concepts. Method 700 can be performed by trainer 302, e.g., in one or more training processes. Method 700 can be implemented on many different types of devices, e.g., by one or more cloud servers, by a client device such as a laptop, tablet, or smartphone, or by combinations of one or more servers, client devices, etc.

Method 700 begins at block 702, where a policy is initialized by a training process and distributed to one or more remote agent processes. For instance, the policy can be initialized using random initial internal parameters, or the agents can be instructed to take random actions for a period of time to gather experiences for initial training.

Method 700 continues at block 704, where experiences are obtained from the agents. For instance, as noted previously, the remote agent processes can asynchronously communicate the experiences to experience data store 306, without maintaining a persistent network connection to the training process.

Method 700 continues at block 706, where the policy is updated based on the experiences. For instance, as noted previously, internal parameters of the policy can be adjusted based on the difference between actual rewards for each experience and expected rewards for each experience.

Method 700 continues at block 708, where the updated policy is distributed to the remote agent processes. For instance, as noted previously, the training process can asynchronously communicate the updated policy to policy data store 304, without maintaining a persistent network connection with the remote agent processes.

Method 700 continues at decision block 710, where a determination is made whether a stopping condition has been reached. The stopping condition can define a specified quantity of computational resources to be used (e.g., a budget in GPU-days), a specified performance criteria (e.g., a threshold accuracy), a specified duration of time, a specified number of training iterations, etc.

If the stopping condition has not been reached, the method continues at block 704, where subsequent iterations of blocks 704, 706, and 708 can be performed by the training process. Generally speaking, blocks 704, 706, and 708 can be considered an iterative training procedure that can be repeated over multiple iterations until a stopping condition is reached.

If the stopping condition has been reached, method 700 can continue to block 712, where a final policy is distributed to the remote agent processes by the training process responsive to completion of training. Block 712 can also include instructing the agents to enter inference mode.

Generally speaking, blocks 704, 706, and 708 can be performed for two or more iterations prior to distributing a final policy at block 712. The experiences obtained for a single iteration of block 704 can include multiple experiences obtained using the same policy, from one or more remote agents. Thus, for instance, the experiences obtained in a given iteration of block 704 and used to update the policy at block 706 can include different actions taken in different environmental contexts by a particular agent using the same set of internal policy parameters to determine the different actions.

In other cases, however, experiences obtained using multiple iterations of the policy can be used when a single training iteration is performed. For instance, referring to FIG. 3, trainer 302 can train using any experiences in buffer 308. As new training experiences are added to the buffer, older experiences can be evicted, and a training iteration can be performed on each experience in the buffer irrespective of which iteration of the policy was used to obtain a given experience.

### Example Agent Method

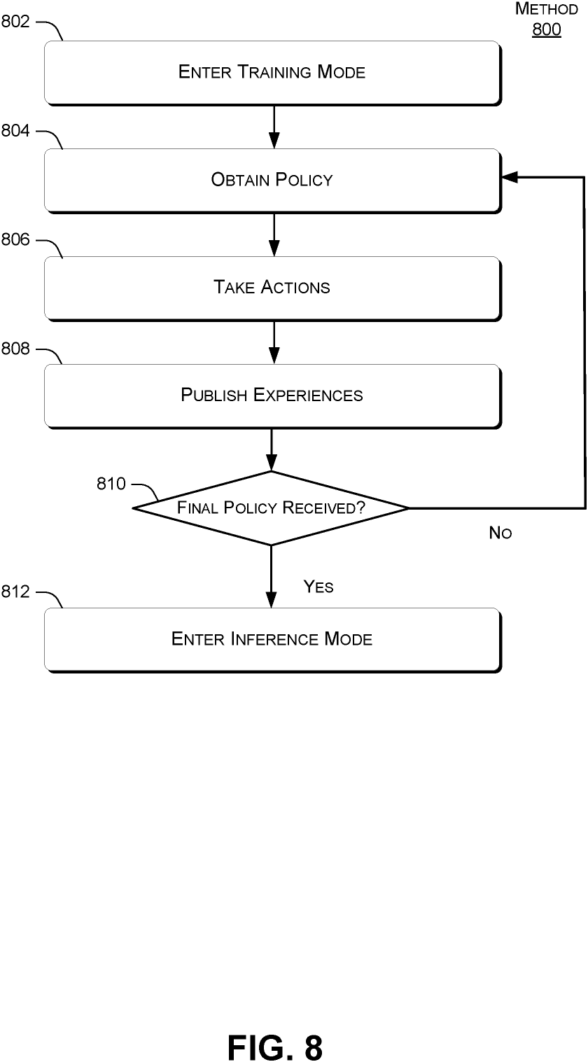

FIG. 8 illustrates an example method 800, consistent with some implementations of the present concepts. Method 800 can be performed by agent 102, e.g., executing in a remote agent process. Method 800 can be implemented on many different types of devices, e.g., by one or more cloud servers, by a client device such as a laptop, tablet, or smartphone, or by combinations of one or more servers, client devices, etc.

Method 800 begins at block 802, where the agent enters training mode. This can involve configuring the agent to balance exploration vs. exploitation of a reward space with relatively high emphasis on exploration, e.g., by setting a relatively high value of an epsilon hyperparameter for an epsilon greedy strategy or a relatively high temperature hyperparameter for a Softmax function.

Method 800 continues at block 804, where an updated policy is obtained. For instance, the agent process can retrieve the updated policy via asynchronous communication with policy data store 304, without maintaining a persistent network connection with the training process.

Method 800 continues at block 806, where the agent process takes actions in the environment by executing the policy locally. For instance, the agent can map context information describing the environment into context features, input the context features to the policy, and select an action to take based on an output of the policy. The policy can map the context features to probability distributions of potential actions, and the agent process can randomly select actions based on the output of the policy, e.g., by selecting actions according to the probability distributions.

Method 800 continues at block 808, where experiences are published by the agent process. For instance, the agent process can publish the experiences via asynchronous communication with experience data store 306, without maintaining a persistent network connection with the training process.

Method 800 continues at decision block 810, where a determination is made whether a final policy has been received. If a final policy has not been received, the method continues at block 804, where subsequent iterations of blocks 804, 806, and 808 can be performed. Generally speaking, blocks 804, 806, and 808 can be considered an iterative experience-gathering procedure that can be repeated over multiple iterations until a final policy is received.

If a final policy has been received, method 800 can continue to block 812, where the agent enters inference mode responsive to receiving the final policy. In inference mode, the agent can stop publishing experiences to the trainer. In addition, the agent can always, or more frequently, take the action with the highest expected reward according to the final policy. This can be accomplished, for instance, by reducing epsilon to zero or another small value for an epsilon-greedy exploration strategy, or by reducing a Softmax temperature to zero or another small value.

Generally speaking, blocks 804, 806, and 808 can be performed for two or more experience-gathering iterations prior to receiving a final policy at block 812. The experiences published for a single iteration of block 808 can include multiple experiences obtained using the same policy. Thus, for instance, the published experiences can include different actions taken in different environmental contexts by a particular agent using the same set of internal policy parameters to determine the different actions.

As noted previously, executing the final policy can generally tend to prioritize exploitation vs. exploration, whereas training can tend to place a somewhat greater emphasis on exploration. This can be accomplished in different ways depending on the specific reinforcement learning techniques being employed. For instance, in implementations where Softmax is employed, the trainer can send different temperature hyperparameters to the agent to use during training and inference. Likewise, in implementations where epsilon greedy strategies are employed, the trainer can send different epsilon hyperparameters to the agent to use during training and inference. While such hyperparameters may generally favor exploitation during inference, in some cases inference mode is not necessarily fully deterministic, as some stochastic behavior can be beneficial during inference. For instance, an agent stuck in a particular location in a video game can escape by taking actions that are not expected to give the highest reward.

Additional information regarding hyperparameters for reinforcement learning can be found, for example, at Mnih et al., “Playing Atari with Deep Reinforcement Learning,” arXiv preprint arXiv:1312.5602. Dec. 19, 2013; He et al., “Determining the Optimal Temperature Parameter for Softmax Function in Reinforcement Learning,” Applied Soft Computing, Sep. 1, 2018, 70:80-5.; and Schulman et al., “Proximal Policy Optimization Algorithms,” arXiv preprint arXiv:1707.06347, Jul. 20, 2017. Note that, when using Proximal Policy Optimization, the trainer can adjust an entropy hyperparameter to control the extent to which the policy encourages stochastic behavior. In this case, the trainer does not necessarily need to send the entropy hyperparameter to the agent. Various other strategies to balance exploration vs. exploitation are also contemplated, and depend to some extent on the specific reinforcement learning techniques being employed. The disclosed implementations are compatible with a wide range of reinforcement learning algorithms and are not limited to specific model structures, learning strategies, or exploration strategies.

### First Example Use Case

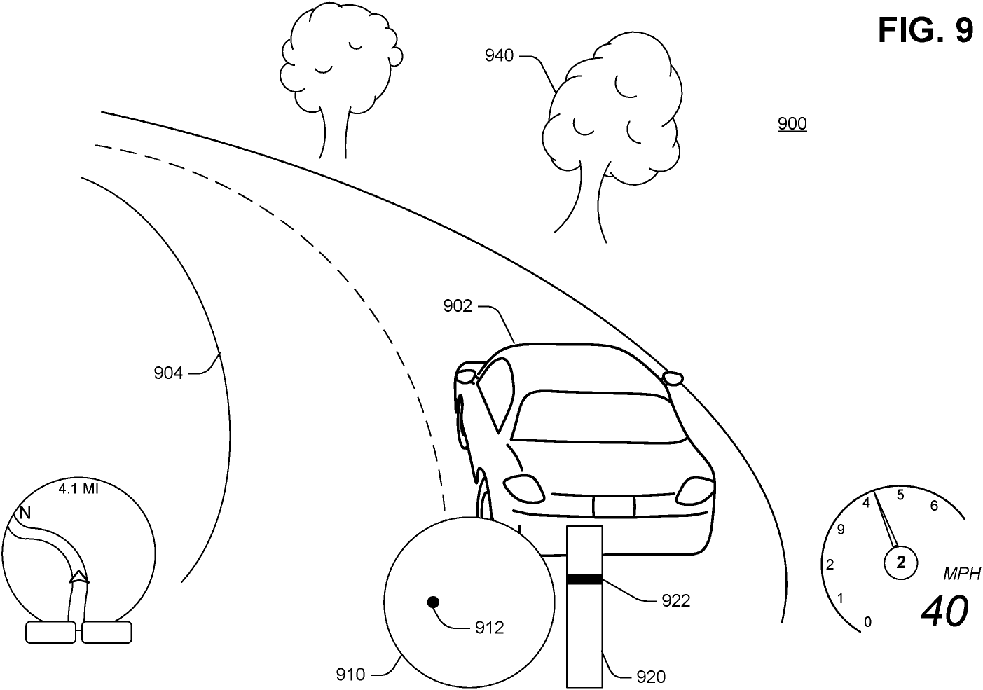

The disclosed implementations can be employed in a wide range of scenarios. FIG. 9 illustrates a video game scenario, where an agent can be trained to play a driving video game using reinforcement learning.

In FIG. 9, a car 902 is shown moving along a road 904. FIG. 9 also shows a directional representation 910 and a trigger representation 920, which represent controller inputs to the driving game. Generally, the directional representation conveys directional magnitudes for a directional input mechanism on a video game controller, e.g., a thumb stick for steering the car. Likewise, the trigger representation 920 conveys the magnitude of a trigger input on the video game controller, e.g., for controlling the car’s throttle. Other input mechanisms can be employed for discrete actions such as shooting guns or temporary turbo boost functionality, but these input mechanisms are not shown in FIG. 9.

Directional representation 910 is shown with a directional input 912, and trigger representation 920 shows a trigger input 922. These are examples of inputs that can be generated by an agent that is playing the video game. In some cases, the agent can receive context obtained from the game, e.g., a subset of pixels from an image output by the video game. In addition, the agent can receive logical descriptions of objects present in the game, e.g., by ray casting from the car 902 to identify road 904 and/or tree 940.

Given this environmental context, the agent can compute directional and trigger inputs as selected actions using a current policy. Then, a reward can be calculated based on a defined reward function. For instance, the reward function could grant a reward based on how far car 902 travels along road 904, based on average speed, based on avoiding obstacles or crashes, achieving new game levels, discovering new areas on a racecourse, etc. The agent can employ features such as raw video from the application as well as features such as agent position and/or velocity, as well as features obtained via ray casting such as object types, distance from the objects, and/or azimuth to the objects.

### Second Example Use Case

Another scenario where the disclosed implementations can be employed relates to using agents to determine technical configurations for a video call application. For instance, the agents can receive API calls from the application, where the API call identifies multiple different technical configurations to the agent as well as context reflecting the technical environment in which video calls will be conducted. Each technical configuration is a potential action for the agent.

One example of a potential technical configuration for a video call application is the playout buffer size. A playout buffer is a memory area where VOIP packets are stored, and playback is delayed by the duration of the playout buffer. Generally, the use of playout buffers can improve sound quality by reducing the effects of network jitter. However, because sound play is delayed while filling the buffer, conversations can seem relatively less interactive to the users if the playout buffer is too large.

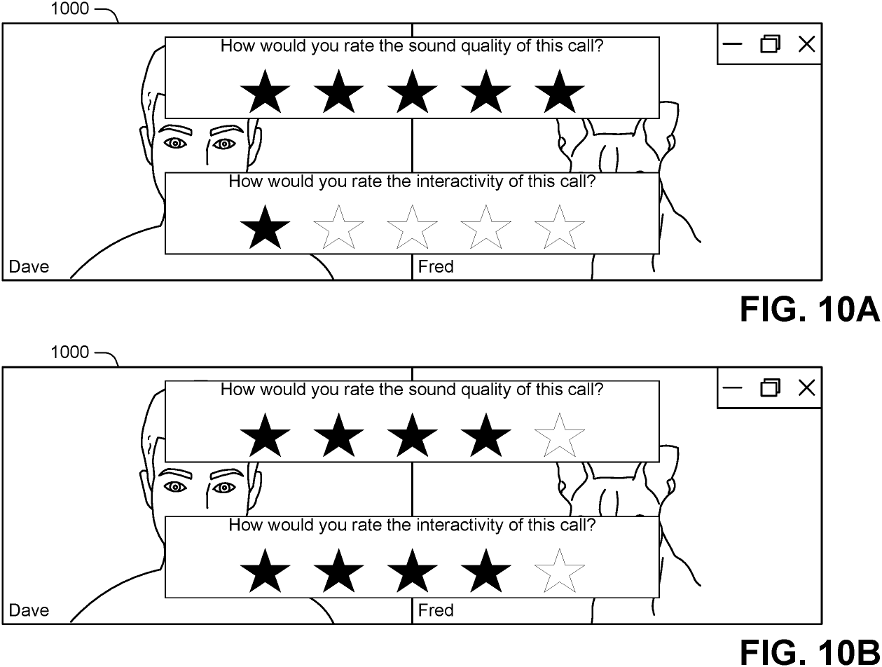

A video call application could have a default configuration that uses a large playout buffer. While this reduces the likelihood of poor sound quality, large playout buffers imply a longer delay from packet receipt until the audio/video data is played for the receiving user, which can result in perceptible conversational latency. FIG. 10A illustrates a video call GUI 1000 with high sound quality ratings, but low interactivity ratings, which reflects how a human user might perceive call quality using such a configuration.

Assume that the agents are deployed with a reward function that considers both whether the playout buffer becomes empty as well as the duration of the calls. Here, the agent may learn that larger playout buffers tend to empty less frequently, but that calls with very large playout buffers tend to be terminated early by users that are frustrated by the relative lack of interactivity. Thus, each agent may tend to learn to choose a moderate-size playout buffer that provides reasonable call quality and interactivity. FIG. 10B illustrates video call GUI 1000 with relatively high ratings for both sound quality and interactivity.

With respect to feature definitions for video call applications, one feature that an agent might consider is network jitter, e.g., the variation in time over which packets are received. Jitter can be measured over any time interval, e.g., the variation in packet arrival times can be computed over just a few packets or over a longer duration (e.g., an entire call). Other features might represent the location and identities of parties on a given call, whether certain parties are muting their microphones or have turned off video, network delay, whether users are employing high-fidelity audio equipment, whether a given user is sending multicast packets, etc. The agent may be able to choose actions that control the size of the playout buffer as well as any other parameters the agent may be able to act on, e.g., VOIP packet size, codec parameters, etc. The reward function can consider environmental reactions such as buffer over- or under-runs, quiet periods during calls, call duration, etc. In some cases, automated characterization of sound quality or interactivity can be employed to obtain reaction features for these implementations.

### Example Graphical Interface

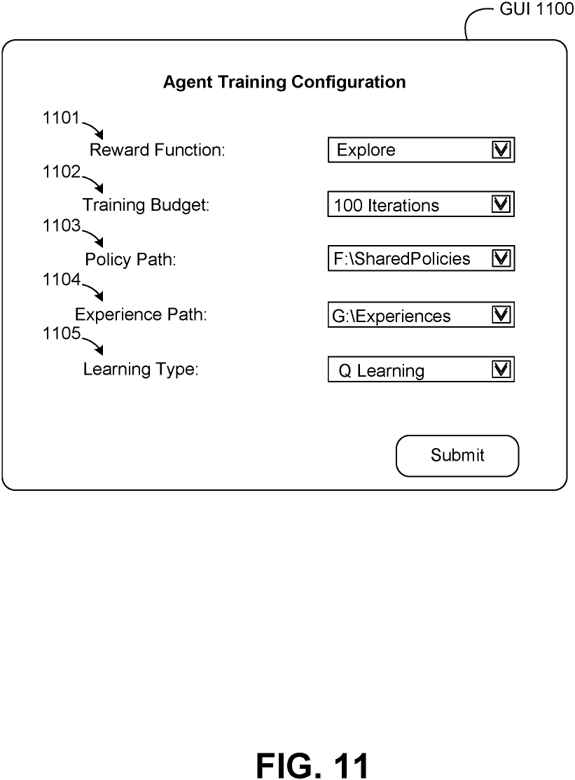

FIG. 11 illustrates an example configuration graphical user interface (“GUl”) 1100 that can be presented via the trainer 302 to configure certain aspects of reinforcement learning. For instance, reward function element 1101 allows a user to specify a particular reward function to use, e.g., one that rewards exploring new areas of a video game. Training budget element 1102 allows a user to specify a training budget to use before finalizing a policy and entering inference mode. Policy path element 1103 allows a user to specify a path where policies are published by the trainer and retrieved by the agents, e.g., a network location of policy data store 304. Experience path element 1104 allows a user to specify a path where experiences are published by the agents and retrieved by the trainer, e.g., a network location of experience data store 306. Learning type element 1105 allows a user to specify the type of learning employed by the trainer, e.g., Q learning, policy gradient, etc. Other elements can also be provided for configuring hyperparameters, e.g., learning rates, values for epsilon or temperature in learning mode, values for epsilon or temperature in inference mode, etc.

When the user clicks submit, the trainer 302 can configure itself and the remote agents 102 according to the user selections entered to configuration GUI 1100. For instance, the trainer can publish an initial policy and reward function to the agents by communicating these items to policy data store 304 at the path specified by policy path element 1103. The trainer can gather experiences from the remote agents by retrieving the experiences from experience data store 306 at the path specified by experience path element 1104. The trainer can implement the learning algorithm specified by learning type element 1105 until the training budget specified by training budget element 1102 is exhausted, and then send the final policy to the remote agents.

### Technical Effect

The disclosed implementations offer several advantages over conventional techniques for distributed reinforcement learning. One drawback of conventional techniques is that reinforcement learning is often implemented in single-threaded programming languages such as Python. While such programming languages may offer a wide range of user-friendly reinforcement learning libraries, the lack of multi-threading support can cause performance issues.

For instance, a single trainer process could theoretically service multiple remote agents by opening network connections to each remote agent, receiving environmental context from each agent, and sending each agent instructions for which action to take. However, maintaining numerous persistent connections in a single process is cumbersome, and it is not feasible to train concurrently while executing the policy or even to execute the policy concurrently for different agents.

Using a trainer to distribute policies to separate worker processes (e.g., on different computing devices) can allow the trainer to buffer experiences and train asynchronously, while the worker processes execute the policy and synchronously instruct the remote agents over a network. However, this approach still involves the use of a persistent network connection between each worker process and a corresponding remote agent, and also involves the remote agent waiting to receive instructions from the worker process before acting. From a software development perspective, the persistent network connections can also introduce debugging complexity, e.g., as remote agents may experience networking timeouts when breakpoints are set in worker code, and vice-versa.

In contrast, the disclosed implementations allow remote agents to take actions and collect experiences without centralized coordination. Thus, the remote agents can act more quickly to changing environmental conditions, because the remote agents do not need to await instructions from a trainer or worker process. This can improve learning by the remote agents because the agents execute policies locally during both training and inference mode, instead of waiting until the final policy is available to execute the policy locally. Even assuming a very fast network connection where there is not normally enough delay to prevent the agent from acting quickly, occasional network instability can nevertheless introduce latency that affects how the agent acts. By executing the policy locally on the agent, network instability issues can be mitigated, thus ensuring that the training environment more closely resembles the environment that the agent will operate in when executing the final policy.

Furthermore, the disclosed implementations do not necessarily involve the use of persistent network connections during training. Instead, by storing policies and experiences at network locations accessible to both the agents and the trainer, the trainer and agents can act in parallel without explicit coordination. This further facilitates debugging of code at both the agent and the trainer, because network timeouts are unlikely to influence the debugging process in the absence of persistent network connections.

In addition, remote implementation of the policy allows the agents to react more quickly to changing environmental conditions. As a consequence, the experiences gathered by the agent during training more closely resemble the experiences that the agent will observe in inference mode. This is in contrast to prior approaches where agents do not implement the policy themselves during training.

### Additional Use Cases

As noted previously, the disclosed implementations can be employed for a wide variety of use cases, in a wide range of technical environments. For instance, consider an agent playing a video game, as described above. The agent can take actions at a predetermined interval, e.g., at the video frame rate of the output of the video game. In some implementations, multiple computing devices in a data center can each execute an instance of the video game and the agent locally (e.g., on a gaming console). The policy can be implemented using a neural network having a convolutional layer that evaluates the video and maps the video output to action probabilities (such as user control inputs), e.g., using a fully-connected layer.

This scenario can be useful for game development scenarios such as debugging video game code and/or exploring large virtual areas provided by the video game to ensure all of the virtual area is reachable. Considering that some video games have frame rates of 120 frames per second, this could involve 240 communications per second with a centralized trainer if the policy is not implemented locally by the agent, since each action involves two communications - one to send experiences and/or context to the device that implements the policy, and another to receive the selected action from the device that implements the policy. The disclosed implementations can significantly reduce network traffic, e.g., the agent could receive an updated policy every second using a single network communication and perform 120 actions using that policy before another network communication to obtain the next iteration of the policy. Similarly, the agent can send 120 experiences to the trainer in a single communication.

Furthermore, when training video games or virtual reality applications, the frame rate of the application can be increased to speed up the rate of training. Generally, frame rates of such applications are set to accommodate human users. Because agents can react far more quickly than humans, the agents can play games “faster” than a human by speeding up the application itself, as limited by the processor (CPU or GPU) on which the application is executing. In turn, this allows for training to proceed more quickly, as training is often limited not by the rate at which the trainer can update parameters, but rather by the rate at which the agent gathers experiences. Thus, local policy execution and asynchronous experience gathering allow for increasing the rate at which experiences can be gathered.

As another example, consider an agent that learns how to pilot a drone aircraft using simulations. Again, multiple computing devices can implement local instances of an agent that pilots the drone in varying virtual scenarios, before the agents are deployed to fly drones in real-world conditions using a final policy. Because the agents are able to execute the policy locally during training, the agents can react more quickly to certain scenarios than would be the case if the agents perform network communications before every action. This can be particularly important for scenarios such as terrain-following flight modes that automatically adjust the altitude of the drone to fly a specified height above the ground, as a relatively short network timeout could result in a collision.

As yet another example, consider heating and air conditioning scenarios. Agents can be deployed on smart thermostats to control heat pumps, furnaces, air conditioners, air handlers, and other HVAC equipment. The agents can learn using a reward function to minimize the energy cost for each household by determining when to turn on and off individual items of HVAC equipment. Many people prefer to not have Wi-Fi devices constantly on in their homes due to concerns about radio emissions. Instead, an agent on a smart thermostat could retrieve an updated policy relatively infrequently, e.g., once per day, and can take multiple actions over the course of the next 24 hours to control HVAC equipment without further network communications.

### Device Implementations

As noted above with respect to FIG. 6, system 600 includes several devices, including an agent device 610, an agent device 620, an agent device 630, and a training server 640. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 650. Without limitation, network(s) 650 can include one or more local area networks (LANs), wide area networks (WANs), the Internet, and the like.

Various examples are described above. Additional examples are described below. One example includes a method comprising performing two or more training iterations to update a policy, individual training iterations comprising by a training process executing on a training computing device, obtaining experiences representing reactions of an environment to actions taken by a plurality of remote agent processes according to the policy, wherein the remote agent processes execute the policy on remote agent computing devices and the experiences are obtained from the remote agent computing devices over a network, by the training process, updating the policy based on the reactions of the environment to obtain an updated policy, and by the training process, distributing the updated policy over the network to the plurality of remote agent processes.

Another example can include any of the above and/or below examples where the experiences are obtained by the training process from an experience data store populated with the experiences by the plurality of remote agent processes.

Another example can include any of the above and/or below examples where distributing the updated policy comprises sending the updated policy to a policy data store accessible to the plurality of remote agent processes.

Another example can include any of the above and/or below examples where the experience data store and the policy data store comprise one or more of a shared network folder, a persistent cloud queue, or a memory location on the training computing device, the experience data store and the policy data store being accessible to the remote agent computing devices via persistent or non-persistent network connections.

Another example can include any of the above and/or below examples where the method further comprises completing training of the policy responsive to reaching a stopping condition.

Another example can include any of the above and/or below examples where the method further comprises responsive to completion of the training, providing a final policy to the plurality of remote agent computing devices.

Another example can include any of the above and/or below examples where individual experiences obtained from the remote agent processes include rewards for corresponding actions taken by the remote agent processes in the environment, the rewards being determined according to a reward function.

Another example can include any of the above and/or below examples where updating the policy involves adjusting internal parameters of a reinforcement learning model to obtain the updated policy.

Another example can include any of the above and/or below examples where the policy maps environmental context describing states of the environment to probability distributions of potential actions and the remote agent processes randomly select actions according to the probability distributions.

Another example can include any of the above and/or below examples where the actions include technical configurations (e.g., buffer sizes, packet sizes, codec parameters) for an application that are selected by the agent based on features relating to network conditions (e.g., jitter, delay).

Another example can include a method comprising performing two or more experience-gathering iterations, individual experience-gathering iterations comprising by an agent process executing on an agent computing device, obtaining an updated policy provided by a training process on a training computing device, wherein the training computing device is remote from the agent computing device and the updated policy is obtained over a network by the agent process, taking actions in an environment by executing the updated policy locally on the agent computing device, and by the agent process, publishing experiences representing reactions of the environment to the actions taken according to the updated policy, wherein the experiences are published to the training process to further update the policy for use in a subsequent experience-gathering iteration by the agent process.

Another example can include any of the above and/or below examples where the experiences are published to an experience data store that populated with other experiences by one or more other agent processes that are also remote from the training computing device, and the updated policy is updated by the training process based on the experiences and the other experiences.

Another example can include any of the above and/or below examples where the updated policy is obtained from a policy data store that is accessible by the one or more other agent processes to obtain the updated policy.

Another example can include any of the above and/or below examples where taking the actions comprises inputting context features describing the environment into the updated policy, and selecting the actions based at least on output determined by the updated policy according to the context features.

Another example can include any of the above and/or below examples where the output of the updated policy comprising a probability distribution over available actions, the actions being selected randomly from the probability distribution.

Another example can include any of the above and/or below examples where the method further comprises receiving a final policy from the training process after the two or more experience-gathering iterations, and taking further actions in the environment based at least on the final policy.

Another example can include any of the above and/or below examples where the method further comprises performing the two or more experience-gathering iterations in a training mode and entering inference mode when using the final policy.

Another example can include any of the above and/or below examples where the method further comprises computing rewards for the reactions of the environment to the actions taken by the agent, and publishing the rewards with the experiences.

Another example can include any of the above and/or below examples where the updated policy comprising a neural network having a convolutional layer, the environment comprising video from an application, wherein taking the actions involves inputting the video to the neural network and selecting the actions based on output of the neural network, and the actions involve providing control inputs to the application.

Another example can include any of the above and/or below examples where the actions include technical configurations (e.g., buffer sizes, packet sizes, codec parameters) for an application that are selected by the agent based on features relating to network conditions (e.g., jitter, delay).

Another example can include a system comprising a training computing device comprising a processor, and a storage medium storing instructions which, when executed by the processor, cause the training computing device to execute a training process configured to perform two or more training iterations to update a policy, individual training iterations comprising obtaining experiences representing reactions of an environment to actions taken by a plurality of remote agent processes according to the policy, wherein the remote agent processes execute the policy on remote agent computing devices and the experiences are obtained from the remote agent computing devices over a network, using reinforcement learning, updating the policy based on the reactions of the environment to obtain an updated policy, and distributing the updated policy over the network to the plurality of remote agent processes.

Another example can include any of the above and/or below examples where the system further comprises the remote agent computing devices, wherein the remote agent processes are configured to perform two or more iterations of an experience-gathering process in a training mode to gather the experiences according to at least two corresponding iterations of the updated policy provided by the training process to the plurality of remote agent processes, and responsive to receiving a final policy from the training process, enter inference mode and take further actions in the environment by executing the final policy.

Another example can include any of the above and/or below examples where the two or more training iterations being performed in the absence of a persistent network connection with the plurality of remote agent computing devices.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
performing two or more training iterations to update a policy, individual training iterations comprising:
by a training process executing on a training computing device, obtaining experiences representing reactions of an environment to actions taken by a plurality of remote agent processes according to the policy, wherein the remote agent processes execute the policy on remote agent computing devices and the experiences are obtained from the remote agent computing devices over a network;
by the training process, updating the policy based on the reactions of the environment to obtain an updated policy; and
by the training process, distributing the updated policy over the network to the plurality of remote agent processes.

2. The method of claim 1, wherein the experiences are obtained by the training process from an experience data store populated with the experiences by the plurality of remote agent processes.

3. The method of claim 2, wherein distributing the updated policy comprises sending the updated policy to a policy data store accessible to the plurality of remote agent processes.

4. The method of claim 3, wherein the experience data store and the policy data store comprise one or more of a shared network folder, a persistent cloud queue, or a memory location on the training computing device, the experience data store and the policy data store being accessible to the remote agent computing devices via persistent or non-persistent network connections.

5. The method of claim 1, further comprising:
completing training of the policy responsive to reaching a stopping condition.

6. The method of claim 5, further comprising:
responsive to completion of the training, providing a final policy to the plurality of remote agent computing devices.

7. The method of claim 1, wherein individual experiences obtained from the remote agent processes include rewards for corresponding actions taken by the remote agent processes in the environment, the rewards being determined according to a reward function.

8. The method of claim 7, wherein updating the policy involves adjusting internal parameters of a reinforcement learning model to obtain the updated policy.

9. The method of claim 8, wherein the policy maps environmental context describing states of the environment to probability distributions of potential actions and the remote agent processes randomly select actions according to the probability distributions.

10. A method comprising:
performing two or more experience-gathering iterations, individual experience-gathering iterations comprising:
by an agent process executing on an agent computing device, obtaining an updated policy provided by a training process on a training computing device, wherein the training computing device is remote from the agent computing device and the updated policy is obtained over a network;
by the agent process, taking actions in an environment by executing the updated policy locally on the agent computing device; and
by the agent process, publishing experiences representing reactions of the environment to the actions taken according to the updated policy, wherein the experiences are published to the training process to further update the policy for use in a subsequent experience-gathering iteration by the agent process.

11. The method of claim 10, wherein the experiences are published to an experience data store that populated with other experiences by one or more other agent processes that are also remote from the training computing device, and the updated policy is updated by the training process based on the experiences and the other experiences.

12. The method of claim 11, wherein the updated policy is obtained from a policy data store that is accessible by the one or more other agent processes to obtain the updated policy.

13. The method of claim 11, wherein taking the actions comprises:
inputting context features describing the environment into the updated policy; and
selecting the actions based at least on output determined by the updated policy according to the context features.

14. The method of claim 13, the output of the updated policy comprising a probability distribution over available actions, the actions being selected randomly from the probability distribution.

15. The method of claim 11, further comprising:
receiving a final policy from the training process after the two or more experience-gathering iterations; and
taking further actions in the environment based at least on the final policy.

16. The method of claim 15, further comprising:
performing the two or more experience-gathering iterations in a training mode and entering inference mode when using the final policy.

17. The method of claim 11, further comprising:
computing rewards for the reactions of the environment to the actions taken by the agent; and
publishing the rewards with the experiences.

18. The method of claim 11, the updated policy comprising a neural network having a convolutional layer, the environment comprising video from an application, wherein taking the actions involves inputting the video to the neural network and selecting the actions based on output of the neural network, and the actions involve providing control inputs to the application.

19. A system comprising:
a training computing device comprising:
a processor; and
a storage medium storing instructions which, when executed by the processor, cause the training computing device to execute a training process configured to:
perform two or more training iterations to update a policy, individual training iterations comprising:
obtaining experiences representing reactions of an environment to actions taken by a plurality of remote agent processes according to the policy, wherein the remote agent processes execute the policy on remote agent computing devices and the experiences are obtained from the remote agent computing devices over a network;
using reinforcement learning, updating the policy based on the reactions of the environment to obtain an updated policy; and
distributing the updated policy over the network to the plurality of remote agent processes.

20. The system of claim 19, further comprising the remote agent computing devices, wherein the remote agent processes are configured to:
perform two or more iterations of an experience-gathering process in a training mode to gather the experiences according to at least two corresponding iterations of the updated policy provided by the training process to the plurality of remote agent processes; and
responsive to receiving a final policy from the training process, enter inference mode and take further actions in the environment by executing the final policy.

21. The system of claim 19, the two or more training iterations being performed in the absence of a persistent network connection with the plurality of remote agent computing devices.
